(19) United States
(12) Patent Application Publication
(10) Pub. No.: US 2006/0071885 A1
(43) Pub. Date: Apr. 6, 2006

(54) Self-emission device

(75) Inventor: Yoshinori Fukuda, Yamagata-ken (JP)

Correspondence Address: ARENT FOX PLLC, 1050 CONNECTICUT AVENUE, N.W., SUITE 400, WASHINGTON, DC, 20036, US

(73) Assignee: TOHOKU PIONEER CORPORATION

(21) Appl. No.: 11/235,228

(22) Filed: Sep. 27, 2005

(30) Foreign Application Priority Data
Oct. 5, 2004 (JP) 2004-292782

(51) Int. Cl. G09G 3/30

(52) U.S. Cl. 345/76

(57) ABSTRACT

It is an object of the present invention for a self-emission device to maintain an acceptable luminescence by removing internal electric charges from its self-emission element during a non-driving period of the self-emission device. The device comprises i) a self-emission element formed by interposing a luminescent layer between a pair of electrodes and ii) control means for controlling the emission/non-emission of the self-emission element. The self-emission element is formed by laminating, on a substrate, a first electrode (lower electrode), a layered structure, a second electrode (upper electrode), with the upper and lower electrodes being connected to the control means by way of lead wires. Further, with respect to at least one of the two electrodes (with respect to both of the two electrodes in the illustrated example) of the self-emission element, there is provided an internal electric charge discharging means which forms an electric charge flowing passage for discharging internal electric charges from the self-emission element when the driving of the control means has been ended.

### BACKGROUND OF THE INVENTION

The present invention relates to a self-emission device.

The present application claims priority from Japanese Application No. 2004-292782, the disclosure of which is incorporated herein by reference.

A self-emission device such as an organic EL (Electroluminescence) device and an organic light emitting diode (OLED) has been attracting considerable public attention since it can provide a highly desirable function when being used as a light source in a flat display, an illumination appliance, or a scanner. In particular, a display apparatus containing such a self-emission device can provide a desired brightness efficiency in various colors can be driven by a voltage which is as low as several volts to ten and several volts, and has a high visibility even if it is observed from an inclined angle.

Such self-emission device includes as light emission element at least one self-emission element whose basic structure is such that a semiconductor layer having p-n junction is interposed between an anode (or a positive hole injection electrode) and a cathode (an electron injection electrode). If a self-emission device is a low molecular type organic EL device, the semiconductor layer will have a laminated structure including at least one organic layer containing a luminescent layer. On the other hand, if the self-emission device is a high molecular type organic EL device, it is possible to form a single-layer structure or a multi-layer laminated structure using bipolar material. By applying an electric voltage to both of the anode and the cathode, positive holes injected and transported from the anode to the organic layer will be recombined with the electrons injected and transported from the cathode into the organic layer (such re-combination occurs within an organic layer such as the luminescent layer), thereby effecting a light emission by virtue of an energy discharge from an excited state obtained through the recombination.

In the above-described self-emission device, since the semiconductor layer (especially an organic layer) is formed into a laminated structure having various functions, carriers (positive holes or electrons) will be charged on interfaces between various layers and interfaces between electrodes and layers. Thus, the trapped carriers (internal electric charges) will form an internal electric field within the self-emission element, which can possibly cause the deterioration of the self-emission element and thus shorten the usable life thereof. In order to avoid the deterioration of the self-emission element possibly caused due to the internal electric charges, Japanese Unexamined Patent Application Publication No. 2003-280585 has suggested a potential fluctuation circuit capable of temporarily reducing the potential at one end (close to an electric power source) of the self-emission element. In this way, since the potential fluctuation circuit can reduce the potential at one electrode of the self-emission element, a reverse bias opposite to a bias at the light emission is applied so as to reset the internal electric charges.

According to the above-described conventional technique, it is possible to reset the internal electric charges within the self-emission element during the driving of the self-emission device. However, when the driving of the self-emission device is finished, since it is impossible to actuate the potential fluctuation circuit, it is impossible to remove the internal electric charges.

On the other hand, even during the non-driving period of the self-emission device, a light irradiation from the outside can generate a photocurrent within the self-emission element, thereby generating the internal electric charges. Further, there is also a possibility that the internal electric charges can be generated due to an electrification caused by the surrounding static electricity. Besides, when the internal electric charges have occurred within the self-emission element during the non-driving period of the self-emission device, if the internal electric charges are irregularly concentrated due to an irregularly layered structure, such layered structure will be damaged due to the formation of leak path or electric discharges, hence causing a deterioration in the light emission performance during the driving of the self-emission device. In addition, an internal electric field formed due to the shifting and accumulation of the internal electric charges can also cause a deterioration in the brightness of self-emission element.

### SUMMARY OF THE INVENTION

This invention has been accomplished in order to solve the afore-mentioned problems and it is an object of the present invention to maintain an acceptable light emission performance for self-emission device by removing internal electric charges from self-emission element during non-driving period of the self-emission device.

To achieve the foregoing object, a self-emission device according to the present invention has at least the following features in the following aspect.

According to the present invention, there is provided a self-emission device including 1) a self-emission element formed by interposing a luminescent layer between a pair of electrodes, and 2) control means for controlling the emission/non-emission of the self-emission element. In particular, with respect to at least one of the electrodes of the self-emission element there is provided an internal electric charge discharging means which forms an electric charge flowing passage for discharging internal electric charges from the self-emission element when the driving of the control means has been ended.

### BRIEF DESCRIPTION OF THE DRAWINGS

These and other objects and advantages of the present invention will become clear from the following description with reference to the accompanying drawings, wherein:

FIG. 1 is an explanatory view showing a self-emission device formed according to one embodiment of the present invention;

FIGS. 2A and 2B are explanatory views showing a more detailed embodiment of the present invention;

FIGS. 3A and 3B are explanatory views showing a more detailed embodiment of the present invention; and

FIG. 4 is an explanatory view showing an example of the structure of a panel (organic EL panel) which is a self-emission device adopting at least one organic EL element which is the foregoing self-emission element formed by interposing an organic layer containing a luminescent layer between a pair of electrodes.

### DETAILED DESCRIPTION OF THE PREFERRED EMBODIMENTS

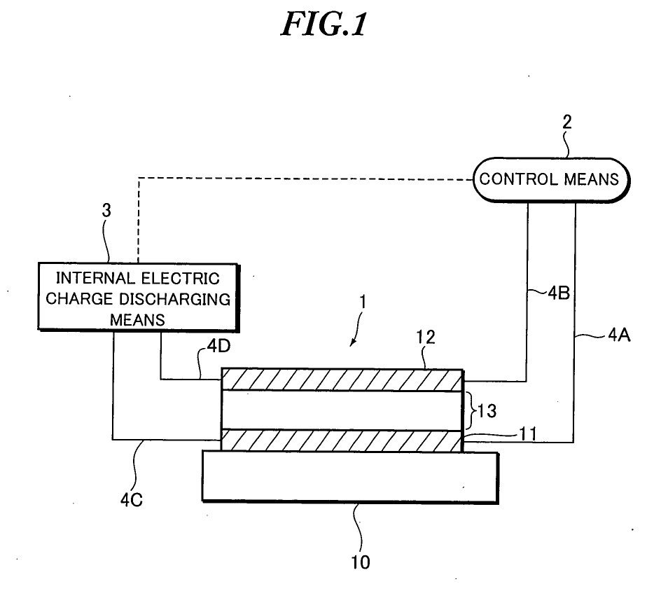

In the following, preferred embodiments of the present invention will be described with reference to the accompanying drawings. FIG. 1 is an explanatory view showing a self-emission device formed according to one embodiment of the present invention. As shown, the self-emission device comprises: 1) a self-emission element 1 including a layered structure 13 containing a luminescent layer and interposed between a pair of electrodes 11, 12, and 2) control means 2 for controlling the emission/non-emission of the self-emission element 1. The self-emission element 1 has a laminated structure mounted on a substrate 10, including a first electrode (lower electrode) 11, a layered structure 13, and a second electrode (upper electrode) 12, with the electrodes 11 and 12 connected to the control means 2 through lead wires 4A and 4B. Further, with respect to at least one of the two electrodes (with respect to both of the two electrodes 11 and 12 in the illustrated example) of the self-emission element 1, there is provided an internal electric charge discharging means 3 which forms an electric charge flowing passage for discharging internal electric charges from the self-emission element 1 when the driving of the control means 2 has been ended. Here, the electrodes 11 and 12 are connected to the internal electric charge discharging means 3 by lead wires 4C and 4D, thus forming an electric charge flowing path by the lead wires 4C and 4D.

In this way, since the internal electric charge discharging means 3 forms an electric charge flowing path for discharging the internal electric charges from the self-emission element 1 when the driving of the control means 2 has been ended, it is possible to pass the internal electric charges through the electric charge flowing path and quickly discharge the same even if the internal electric charges are generated in the self-emission element 1 due to a light emission from the outside or a surrounding static electricity during the non-driving state of the self-emission device. Therefore, it is possible to prevent any troubles possibly caused due to the internal electric charges generated within the self-emission element 1, thereby avoiding any damage or deterioration of the self-emission device even if it is kept in a non-driving state for a long period.

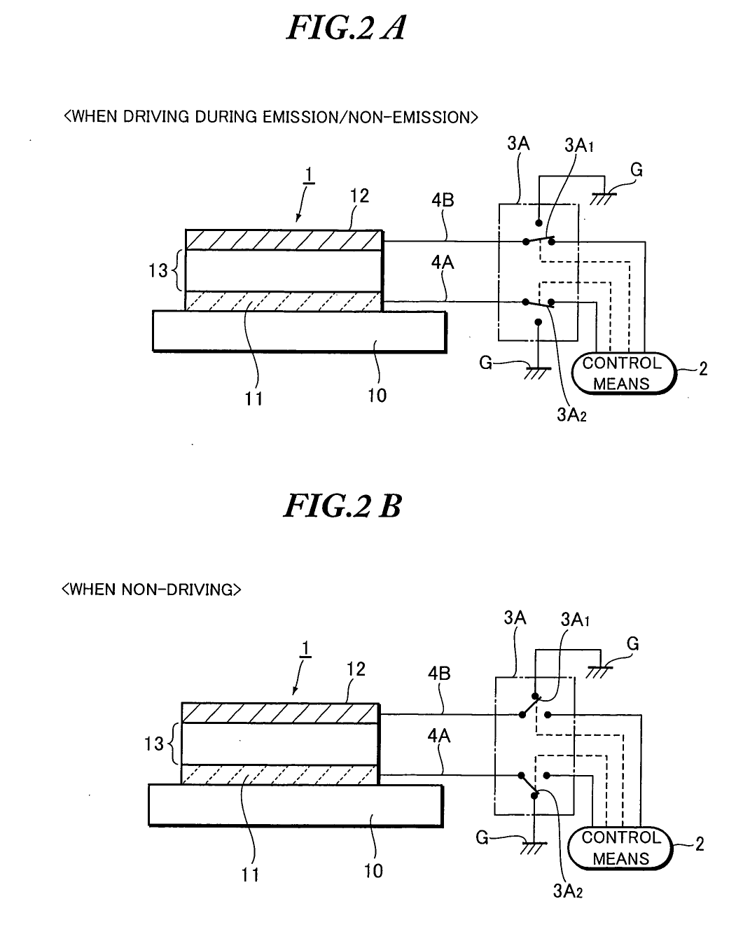

FIGS. 2A and 2B are explanatory views showing a further detailed embodiment according to the present invention (the same portions as those in the above-described embodiment are represented by the same reference numerals and the repeated descriptions are partially omitted). In fact, the self-emission device according to the present embodiment is so formed that its internal electric charge discharging means 3A has line changeover means 3A₁ and 3A₂ which have a function of actuating (when the driving of the control means 2 has been ended) to have at least one electrode (one of the electrodes 11 and 12) of the self-emission element 1 to be earthed to the ground G.

Namely, during the emission/non-emission driving of the self-emission device (as shown in FIG. 2A), the line switchover means 3A₁ and 3A₂ will actuate so that the lead wires 4A and 4B of the electrodes 11 and 12 can be connected to the control means 2. On the other hand, during the non-driving period of the self-emission device (as shown in FIG. 2B), the line switchover means 3A₁ and 3A₂ will actuate so that the lead wires 4A and 4B of the electrodes 11 and 12 can be connected to the ground G. Here, the line switchover means 3A₁ and 3A₂ can be so formed that they will actuate to automatically switchover lines by virtue of signals supplied from the control means 2 (when the foregoing driving has been ended), or to allow a user to switchover lines manually upon confirming that the driving has been ended.

In this way, similar to the embodiment described above, even if internal electric charges occur within the self-emission element 1 during the non-driving period of the self-emission device, these electric charges can be quickly moved to the ground so as to be discharged. Therefore, it is possible to prevent some troubles possibly caused by the internal electric charges present within the self-emission element 1, thereby avoiding any damage or deterioration of the self-emission device even if it is kept in a non-driving state for a long period.

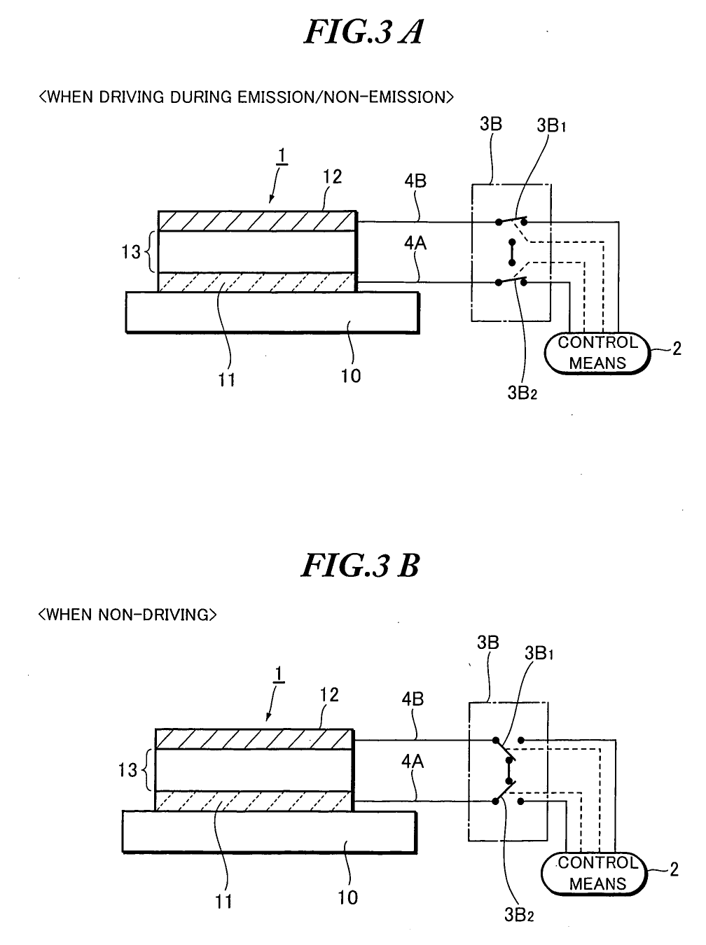

FIGS. 3A and 3B are explanatory views showing a further detailed embodiment of the present invention (the same portions as those in the above-described embodiments are represented by the same reference numerals and the repeated description will be partially omitted). In fact, the self-emission device according to the present embodiment is formed so that its internal electric charge discharging means 3B has line changeover means 3B₁ and 3B₂ which have a short-circuiting function such that they will actuate (when the driving of the control means 2 has been ended) to cause the electrodes 11 and 12 of the self-emission element 1 to become short-circuited.

Namely, during the emission/non-emission driving of the self-emission device (as shown in FIG. 3A), the line switchover means 3B₁ and 3B₂ will so actuate that the lead wires 4A and 4B of the electrodes 11 and 12 can be connected to the control means 2. On the other hand, during the non-driving period of the self-emission device (as shown in FIG. 3B), the line switchover means 3B₁ and 3B₂ will so actuate that the lead wires 4A and 4B of the electrodes 11 and 12 will be connected to each other and thus the electrodes 11 and 12 become short-circuited with each other. Here, the line switchover means 3B₁ and 3B₂ can be so formed that they will actuate to automatically switchover lines by virtue of signals supplied from the control means 2 (when the foregoing driving has been ended), or to allow a user to switchover lines manually upon confirming that the driving has been ended.

In this way, similar to the embodiment described above, even if internal electric charges occur within the self-emission element 1 during the non-driving period of the self-emission device, these electric charges can be quickly moved to the ground so as to be discharged. Therefore, it is possible to prevent some troubles possibly caused by the internal electric charges present within the self-emission element 1, thereby avoiding any damage or deterioration of the self-emission device even if it is kept in a non-driving state for a long period.

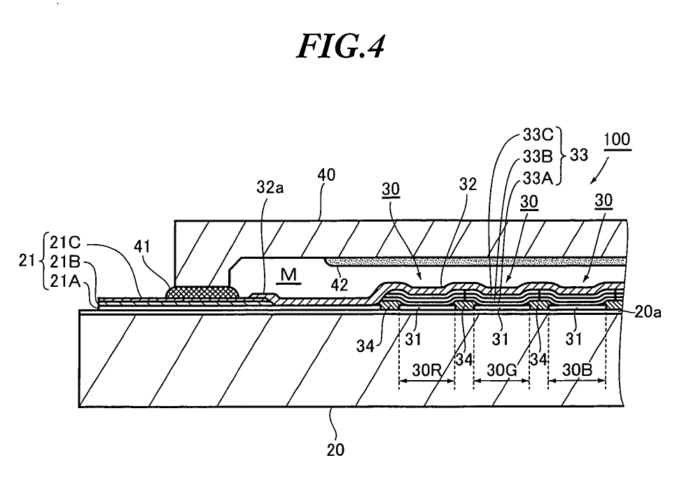

FIG. 4 is an explanatory view showing an example of the structure of a panel (organic EL panel) which is a self-emission device adopting at least one organic EL element which is the foregoing self-emission element formed by interposing an organic layer containing a luminescent layer between a pair of electrodes.

As shown, an organic EL panel 100 is formed by interposing an organic layer 33 containing an organic luminescent layer between first electrodes 31 on one hand and second electrodes 32 on the other, thereby forming a plurality of organic EL elements 30 on the substrate 20. In an example shown in FIG. 4, a silicone coating layer 20a is formed on the substrate 20, and a plurality of first electrodes 31 consisting of transparent electrode material such as ITO and serving as anodes are formed on the silicon coating layer 20a. Further, second electrodes 32 consisting of a metal such as Al and serving as cathodes are formed over the first electrodes 31, thereby forming a bottom emission type panel emitting light from the substrate 20 side. Moreover, the panel also contains an organic layer 33 including a positive hole transporting layer 33A, a luminescent layer 33B, and an electron transporting layer 33C. Then, a cover 40 is bonded to the substrate 20 through an adhesive layer 41, thereby forming a sealing space M on the substrate 20 and thus forming a display section consisting of organic EL elements 30 within the sealing space M.

The foregoing organic EL elements can be manufactured by using any one of well-known conventional methods. These conventional methods include a film formation using a low molecule organic material by means of vacuum deposition, a film formation using a macromolecule organic material by means of printing, and an LITI (Laser-induced Thermal Imaging) method for transferring an organic EL film formed in advance onto a substrate by means of a laser.

A display section consisting of organic EL elements 30, as shown in an example of FIG. 4, is so formed that its first electrodes 31 are divided by at least one patterned insulating layer 34, thereby forming a plurality of unit display areas (30R, 30G, 30B) by virtue of the respective organic EL elements 30 located under the divided first electrodes 31. Further, desiccating means 42 is attached to the inner surface of the sealing cover 40 forming the sealing space M, thereby preventing a deterioration of the organic EL elements which is possibly caused due to moisture.

Moreover, along the edge of the substrate 20 there is formed first electrode layers 21A using the same material and the same step as forming the first electrodes 31, which is separated from the first electrodes 31 by the insulating layer 34. Further, on the lead-out portion of the first electrode layers 21A there is formed a second electrode layers 21B containing a low-resistant metal, an alloy or the like and forming a low-resistant wiring portion. In addition, if necessary, a protection coating layers 21C consisting of IZO or the like is formed on the second electrode layers 21B. In this way, a lead-out wiring portions 21 can be formed which consists of the first electrode layers 21A, the second electrode layer 21B, and the protection coatings 21C. Then, an end portion 32a of each second electrodes 32 are connected to the lead-out wiring portion 21 within the sealing space M.

Here, although the lead-out wiring portion of each first electrodes 31 is not shown in the drawing, such lead-out wiring portion can be formed by extending each first electrodes 31 and leading the same out of the sealing space M. Actually, such lead-out wiring portion can also be formed into an electrode layer containing a low-resistant metal, an alloy, or the like and constituting a low resistant wiring portion, in a manner similar to an example associated with the above-described second electrodes 32.

Next, description will be given in more detail to explain the detailed portions of the aforementioned organic EL panel 100.

a. Electrodes

Either the first electrodes 31 or the second electrodes 32 are set as cathode side, while the opposite side is set as anode side. The anode side is formed by a material having a higher work function than the cathode side, using a transparent conductive film which may be a metal film such as chromium (Cr), molybdenum (Mo), nickel (nickel), and platinum (Pt), or a metal oxide film such as ITO and IZO. In contrast, the cathode side is formed by a material having a lower work function than the anode side, using a metal having a low work function, which may be an alkali metal (such as Li, Na, K, Rb, and Cs), an alkaline earth metal (such as Be, Mg, Ca, Sr, and Ba), a rare earth metal, a compound or an alloy containing two or more of the above elements, or an amorphous semiconductor such as a doped polyaniline and a doped polyphenylene vinylene, or an oxide such as Cr₂O₃, NiO, and Mn₂O₅. Moreover, when the first electrodes 31 and the second electrodes 32 are all formed by transparent materials, it is allowed to provide a reflection film on one electrode side opposite to the light emission side.

The lead-out wiring portion (the lead-out wiring portion 14 and the lead-out wiring portion of the first electrodes 31, as shown in the figure) are connected with drive circuit parts driving the organic EL panel 100 or connected with a flexible wiring board. However, it is preferable for these lead-out wiring portions to be formed as having a low resistance as possible. Namely, the lead-out wiring portions can be formed by laminating low resistant metal electrode layers which may be Ag-alloy, Cr, Al, or the like. Alternatively, they may be formed by single one electrode of low resistant metal.

b. Organic layer

Although the organic layer 33 comprises one or more layers of organic compound materials including at least one organic luminescent layer, its laminated structure can be in any desired arrangement. Usually, in the case of a low molecule organic EL material, as shown in FIG. 4, there is a laminated structure including, from the anode side towards the cathode side, a hole transporting layer 33A, a luminescent layer 33B, and an electron transporting layer 33C. Each of the hole transporting layer 33A, the luminescent layer 33B, and the electron transporting layer 33C can be in a single-layer or a multi-layered structure. Moreover, it is also possible to dispense with the hole transporting layer 33A and/or the electron transporting layer 33C. On the other hand, if necessary, it is allowed to insert other organic layers including a hole injection layer, an electron injection layer and a carrier blocking layer. Here, the hole transporting layer 33A, the luminescent layer 33B, and the electron transporting layer 33C can be formed by any conventional materials (it is allowed to use either a high molecular material or a low molecular material).

With regard to a luminescent material for forming the luminescent layer 33B, it is allowed to make use of a luminescence (fluorescence) when the material returns from a singlet excited state to a base state or a luminescence (phosphorescence) when it returns from a triplet excited state to a base state.

c. Sealing Cover (Sealing Film)

Further, the organic EL panel 100 according to the present invention is a panel formed by tightly covering organic EL elements 30 with a sealing cover 40 made of metal, glass, or plastic. Here, the sealing cover may be a piece of material having a recess portion (a one-step recess or a two-step recess) formed by pressing, etching, or blasting. Alternatively, the sealing cover may be formed by using a flat glass plate and includes an internal sealing space M to be formed between the flat glass plate and the support substrate by virtue of a spacer made of glass (or plastic).

In order to tightly seal up the organic EL elements 30, it is also possible for the sealing cover 40 to be replaced by a sealing film to cover the organic EL elements 30. The sealing film can be formed by laminating a single layer of protection film or a plurality of protection films, and is allowed to be formed by either an inorganic material or an organic material. Here, an inorganic material may be a nitride such as SiN, AlN, and GaN, or an oxide such as SiO, Al₂O₃, Ta₂O₅, ZnO, and GeO, or an oxidized nitride such as SiON, or a carbonized nitride such as SiCN, or a metal fluorine compound, or a metal film, etc. On the other hand, an organic material may be an epoxy resin, or an acryl resin, or a paraxylene resin, or a fluorine system high molecule such as perfluoro olefin and perfluoro ether, or a metal alkoxide such as CH₃OM and C₂H₅OM, or a polyimide precursor, or a perylene system compound, etc. In practice, the above-mentioned lamination and material selection can be effected by appropriately designing the organic EL elements 30.

d. Adhesive Agent

An adhesive agent forming the adhesive layer 41 may be a thermal-setting type, a chemical-setting type (2-liquid mixture), or a light (ultraviolet) setting type, which can be formed by an acryl resin, an epoxy resin, a polyester, a polyolefine. Particularly, it is preferable to use an ultraviolet-setting epoxy resin adhesive agent which is quick to solidify without a heating treatment.

e. Desiccating Means

Desiccating means 42 may be a physical desiccating agent such as zeolite, silica gel, carbon, and carbon nanotube; a chemical desiccating agent such as alkali metal oxide, alkali earth metal oxide, metal halogenide, peroxide chlorine; a desiccating-agent formed by dissolving an organic metallic complex in a petroleum system solvent such as toluene, xylene, an aliphatic organic solvent and the like; and a desiccating agent formed by dispersing desiccating particles in a transparent binder such as polyethylene, polyisoprene, polyvinyl thinnate.

f. Various Types of Organic EL Display Panels

The organic EL panel 100 of the present invention can have various types without departing from the scope of the invention. For example, the light emission type of an organic EL element 30 can be a bottom emission type which emits light from the substrate 20 side, or a top emission type which emits light from a side opposite to the substrate 20, or TOLED type capable of emitting lights from both sides of display panel. Moreover, the EL display panel 100 may be a single color display or a multi-color display. In practice, in order to form a multi-color display panel, it is allowed to adopt a discriminated painting method or a method in which a single color (white or blue) luminescent layer is combined with a color conversion layer formed by a color filter or a fluorescent material (CF manner, CCM manner), a photograph breeching method which realizes a multiple light emission by emitting an electromagnetic wave or the like to the light emission area of a single color luminescent layer, or SOLED (transparent Stacked OLED) method in which two or more colors of unit display areas are laminated to form one unit display area. Further, as a driving manner, it is possible to use a passive driving as shown in the figure in which the upper and lower electrodes are arranged in the form of strips in a mutually orthogonal directions, thereby making it possible to select light emission elements located at intersecting points and thus effect a desired light emission. Moreover, it is also possible to use an active driving manner in which light emission points are selected by virtue of TFT so as to effect a desired light emission. In the case of an active driving manner, if the internal electric charge discharging means (3, 3A, 3) are formed in a process of manufacturing TFT, it is possible to form organic EL elements in the same step as used in forming conventional elements. Furthermore, since an active driving manner for driving organic EL elements can be formed by coating the second electrodes 32, it is possible to form line switchover means (3A₁, 3A₂, 3B₁, 3B₂) so as to connect the second electrodes to the ground G.

According to the above-described embodiment of the present invention, it is possible for a self-emission device to maintain an acceptable luminescence by removing internal electric charges from its self-emission element during a non-driving period of the self-emission device.

While there has been described what are at present considered to be preferred embodiments of the present invention, it will be understood that various modifications may be made thereto, and it is intended that the appended claims cover all such modifications as fall within the true spirit and scope of the invention.

What is claimed is:

1. A self-emission device including: 1) at least one self-emission element formed by interposing a luminescent layer between a pair of electrodes, and 2) control means for controlling the emission/non-emission of the self-emission element,
wherein with respect to at least one of the electrodes of the self-emission element there is provided an internal electric charge discharging means which forms an electric charge flowing passage for discharging internal electric charges from the self-emission element when the driving of the control means has been ended.

2. The self-emission device according to claim 1, wherein the internal electric charge discharging means operates when the driving of the control means has been ended, and has a function which causes at least one of the electrodes of the self-emission element to be earthed.

3. The self-emission device according to claim 1, wherein the internal electric charge discharging means operates when the driving of the control means has been ended, and has a function which causes both of the electrodes of the self-emission element to be short-circuited.
